(19) United States
(12) Patent Application Publication
(10) Pub. No.: US 2018/0186127 A1
(43) Pub. Date: Jul. 5, 2018

(54) BENDING ACTUATOR COMPRISING SHAPE MEMORY ELEMENT

(71) Applicant: INSTITUT FÜR VERBUNDWERKSTOFFE GMBH, Kaiserslautern (DE)

(72) Inventors: Moritz HÜBLER, Neustadt (DE); Lisa Weber, Sindelfingen (DE); Sebastian NISSLE, Kaiserslautern (DE); Martin GURKA, Landau (DE)

(21) Appl. No.: 15/567,859

(22) PCT Filed: Apr. 29, 2016
(86) PCT No.: PCT/DE2016/100196

§ 371 Date: Oct. 19, 2017

(30) Foreign Application Priority Data
Apr. 30, 2015 (DE) 10 2015 106 802.8

(51) Int. Cl. B32B 25/10; B32B 7/08; B32B 25/08; B32B 27/20; B32B 5/02

(52) U.S. Cl. CPC B32B 25/10; B32B 7/08; B32B 2307/734; B32B 27/20; B32B 5/02; B32B 25/08

(57) ABSTRACT

The present invention relates to a bending actuator (1) comprising a plastic base layer (2) and a shape memory element (3) made from shape memory material, which can be actively shortened in a direction of action of the shape memory, wherein the shape memory element (3) is arranged outside the base layer (2) and is mechanically connected to the base layer (2) so that a bending occurs in the bending actuator (1) because of a pull by a contraction (K) of the shape memory element (3) in a direction of action of the shape memory, wherein an intermediate layer (6) is arranged between the shape memory element (3) and the base layer (2) in order to improve the transmission of force between the base layer (2) and the shape memory element (3), to prolong the service life and to reduce the degree of bend of the bending actuator (1), wherein the elasticity module of said intermediate layer (6) is less than the elasticity module of the base layer (2).

This invention relates to a bending actuator, which comprises a plastic base layer and a shape memory element made from shape memory alloy, which can be actively shortened in a direction of action of the shape memory, wherein the shape memory element is arranged outside the base layer and is mechanically connected to the base layer, with the result that bending occurs in the bending actuator because of tension due to contraction of the shape memory element.

In the prior art, there is a known practice of embedding elements made from shape memory alloy in a plastics material. In this way, it is possible to produce an actuator which uses the stresses and strains of the shape memory alloy to bring about deformation of an entire actuator. In particular, bending can be brought about by contraction of a shape memory alloy which is arranged outside a neutral axis of the plastics composite.

In the article “Load Conforming Design and Manufacturing of Active Hybrid Fiber Reinforced Polymer Structure with Integrated Shape Memory Alloy Wires for Actuation Purposes” by M. Hübler, S. Nissle, M. Gurka and U. Breuer in Proceedings of the ACTUATOR 2014, 14^{th} International Conference on New Actuators, Bremen, Germany Jun. 23-25, 2014, for example, a bending actuator was disclosed in which a fiber-reinforced plastic is combined with wires made from a shape memory alloy. In this solution, the shape memory elements are applied to a base layer made from fiber-reinforced plastic. For the purpose of tension-transmitting fastening, the shape memory elements each have at both of their ends a common anchor wire, which is connected to all the shape memory elements at one of the ends thereof. On the base layer, the anchor wires are laminated into a layer made of short fibers, which extends in a region around the anchor wires (see FIG. 3 of the article). To reinforce this region, a further layer containing a glass fiber layer is applied over the layer composed of short fibers, said glass fiber layer extending over the layer of short fibers. In this way, a firm connection can be established between the anchor wires and the base layer at the two ends thereof. A further glass fiber layer, although this is significantly thinner than the base layer, is placed as protection over the shape memory elements on the outside of the bending actuator. An increase in the temperature of the shape memory alloy causes it to contract, as a result of which the bending actuator is bent to an extreme extent, as illustrated in FIG. 6 of the article.

The disadvantage with this solution is that it results in very extreme bending, which is too great for many uses. Moreover, the extreme bending leads to rapid destruction of the bending actuator.

Patent Application US 2009/0301094 A1 discloses the attachment of adjustable flaps on the inner end of an aircraft turbine. These flaps comprise a joint having an element made from fiber composite material, a flexible element and an element made from shape memory material, the change in temperature of which can bring about adjustment of the flap. The flexible element is arranged between the shape memory element and the element made from fiber composite material and, as a material, can comprise a thermosetting polymer such as epoxy resin, polyimide or foam.

The subject matter of the invention is a bending actuator, in which an intermediate layer, the elasticity modulus of which is less than the elasticity modulus of the base layer, is arranged between the base layer and the shape memory element. The elasticity moduli mentioned refer to elasticity moduli which act in a direction of action of the shape memory and are thus relevant to the active bending of the bending actuator. The intermediate layer according to the invention has several advantageous effects.

By virtue of the exceptional strain capacity of the shape memory element, very high shear stresses arise between the base layer and the shape memory element, and these can lead to rapid failure of the connection between the base layer and the shape memory element. Owing to the arrangement of the shape memory element on the intermediate layer, the pronounced strain of the shape memory element is initially introduced into the intermediate layer, which is softer than the base layer. Owing to the lower elasticity modulus of the intermediate layer, the intermediate layer can be deformed with the shape memory element without the occurrence of stresses, which could have a rapid destructive effect on the bending actuator. By means of the deformation of the intermediate layer, the strains of the shape memory element can be reduced to an extent which is tolerable for the base layer and the connection between the base layer and the intermediate layer. The life of the bending actuator is thereby extended.

Moreover, the intermediate layer increases the distance between the shape memory element and the neutral axis of the bending actuator. This has the result that the longitudinal strain of the shape memory element has less of a bending effect on the bending actuator. The intermediate layer therefore advantageously brings about less bending and less movement of the end of the bending actuator. Through the choice of thickness of the intermediate layer, a desired deflection can be set.

The intermediate layer is preferably arranged between the overall shape memory element and the base layer. For this purpose, the shape memory element can be coated with the intermediate layer before being joined to the base layer. This can be accomplished easily and has the advantage that only relevant regions are covered with the intermediate layer. It is also conceivable to coat the entire base layer with the intermediate layer on its side facing the shape memory element. In this way, a pre-coated starting material can be used, for example.

The activation of the shape memory element is preferably accomplished by resistance heating with electric current. However, it is also conceivable for the bending actuator to operate in one or more environments at different temperatures and to be deformed on this basis. When it cools, the bending actuator returns at least approximately to its initial shape.

In one embodiment of the bending actuator, the elasticity modulus of the intermediate layer can be one tenth of or less than one tenth of the elasticity modulus of the base layer. This can be the case, for example, if the base layer is produced from plastic reinforced with long fibers and the intermediate layer is produced from plastic reinforced with short fibers, wherein, in particular, the proportions of fiber in the base layer and the intermediate layer can be adapted in a suitable manner. The said ratio of the elasticity moduli can also be obtained if the base layer is produced from a plastic reinforced with short fibers and the intermediate layer is produced from plastic which is not reinforced with fibers. Another possibility is to produce the base layer from a plastic which is not reinforced with fibers and the intermediate layer from an elastomer.

It is also possible for the elasticity modulus of the intermediate layer to be one hundredth of the elasticity modulus of the base layer or less. A difference of this kind in the elasticity moduli can be achieved, for example, by means of material combinations for the base layer and the intermediate layer in which the base layer is produced from plastic reinforced with long fibers and the intermediate layer is produced from plastic which is not reinforced with fibers or the base layer is produced from plastic reinforced with short fibers and the intermediate layer is produced from elastomer.

In principle, however, a base layer made from plastic reinforced with long or short fibers or not reinforced with fibers and an intermediate layer made from plastic reinforced with long or short fibers or not reinforced with fibers or from elastomer which is reinforced with fibers or not reinforced with fibers in any desired combination in which there is a sufficient difference between the elasticity moduli is conceivable. Glass fibers, carbon fibers or natural fibers can be used as fibers, for example.

It is also conceivable to vary the proportion of long fibers or short fibers in the same or different matrix materials to such an extent that a sufficiently large difference between the elasticity moduli is obtained.

Thermoplastic and thermosetting plastics are suitable as plastics materials for a base layer and/or an intermediate layer, for example.

The choice of materials depends not only on the elasticity modulus but also on the thickness of the intermediate layer since a thick intermediate layer can compensate better for shear stresses between the shape memory elements and the base layer than a thin and thus softer intermediate layer with a smaller layer thickness.

The shape memory element is preferably a metallic shape memory element, in particular one made from a nickel/titanium alloy. However, it is also conceivable to use other shape memory materials, including materials which will be developed in the future.

In another embodiment of the bending actuator, the insertion of the intermediate layer displaces a neutral axis by less than 20% of the thickness of the intermediate layer in respect of bending by the shape memory element. If this is the case, a particularly good reduction of the bending effect of the shape memory element is obtained. This becomes clear from a comparison with a theoretical consideration in which, for the sake of comparison, an intermediate layer made from the same material as the base layer is inserted as the intermediate layer. In that case, the neutral axis is displaced in the direction of the intermediate layer, as is the case also with a soft intermediate layer, but it is displaced to an extent such that, by virtue of its considerable displacement, the neutral axis follows the likewise displaced shape memory element after insertion. As a result, there is a shorter distance between the shape memory element and the neutral axis than when using a soft intermediate layer, and therefore the bending of the shape memory element is reduced to a lesser extent than with a soft intermediate layer. In order to achieve a comparable spacing effect, a very much larger quantity of rigid material than of soft material would have to be added, which would make the bending actuator much more rigid. In order to achieve a smaller displacement of the neutral axis, a corresponding choice of material can be made for the intermediate layer. Moreover, the thickness of the intermediate layer has an effect on the extent of the displacement of the neutral axis, which is all the greater, the higher the elasticity modulus of the intermediate layer. Through a suitable choice of the two said variables, namely the thickness of the intermediate layer and the elasticity modulus thereof, and through calculation of the position of the neutral axis, a person skilled in the art can ensure that the neutral axis is displaced by less than 20% of the thickness of the intermediate layer by the addition of the intermediate layer. As a particular preference, however, the neutral axis is displaced by 10% of the thickness of the intermediate layer or less.

In another embodiment of the invention, the thickness of the intermediate layer is less than 50% of the thickness of the base layer. Practical experience shows that, with such a design rule, the distance created between the shape memory element and the base layer is suitable for many uses of the bending actuator. If an elastomer is used as the intermediate layer, the elasticity modulus thereof can be between 3 and 20 MPa, for example, preferably about 8 MPa.

In another embodiment, the bending actuator is of strip-shaped design. Arranged on the likewise strip-shaped base layer is the intermediate layer, on which one or more shape memory elements extend as far as the two ends in the longitudinal direction. Owing to the length of the relatively small thickness of the strip, a good bending capacity is obtained, thereby making it possible to achieve deflections which are more than merely marginal.

In another embodiment, the shape memory elements are designed as one or more wires, which are arranged in parallel on or in the edge region of the intermediate layer. Design as wires allows rapid heating and cooling in order to bring about and reverse the shape memory effect. It is furthermore conceivable to design the shape memory element as a grid which is produced from shape memory wire in one or more sections. Here, the longitudinal grid bars are designed as shape memory wires in the direction of action of the shape memory. They preferably have uniform spacings relative to one another. The transverse grid bars, which are aligned at an angle, preferably an angle of 90°, thereto, are preferably produced from a material which does not exhibit a shape memory effect. In this way, the deformation is brought about around only one bending axis, which is preferably arranged transversely to a longitudinal direction of the bending actuator. The transverse grid bars can be embedded in plastic, which is connected directly or indirectly, namely, in particular, via the intermediate layer, to the base layer. This plastic is preferably fiber-reinforced in order to be better able to withstand the surface pressure imposed by the anchor element. As a particular preference, use is made of short fibers for reinforcement since these can easily adapt to the shape of the anchor element. The transverse grid bars are preferably uniformly spaced apart and can be omitted in a central region in a direction of action of the shape memory of the shape memory element. This is advantageous if, as in many cases, there are slight changes in the bending radius in the center of the bending actuator, leading to lower requirements on the fastening of the shape memory element to the bending actuator. It is thus possible thereby to save expenditure on production and materials. Irrespective of this, it can be worthwhile to provide an anchor element at a location at which the bending stiffness of the bending actuator changes in a direction of the curvature which is caused by the shape memory element. This can be the case, for example, at a location of a change in thickness and/or width or of a change in the material or the fiber reinforcement thereof or some other change in the second moment of area effective in respect of the actively caused bending. At such locations, there is a change in the bending radius caused by the active deformation of the bending actuator. This, in turn, leads to the necessity of transmitting increased shear forces between the shape memory element and the base layer at these locations. This can be assisted at such locations by one or more anchor elements.

It is also conceivable to embody the shape memory element as one or more thin strips, a film or a thin plate.

In another embodiment of the bending actuator, one or more shape memory elements is/are connected to the base layer by means of an anchor element, thus allowing the shape memory element to transmit tension forces to the base layer in a direction of action of the shape memory via the anchor element. Preferably, tension forces are transmitted by positive engagement between the anchor element and the base layer. Material engagement can be used, in addition. A particular preference for the anchor element is an anchor wire embedded in a plastic which is connected materially and possibly also positively to the base layer. The anchor element is preferably connected in a fixed manner to the shape memory element, e.g. positively or by material engagement, by welding for instance. The anchor element and the shape memory element can be connected to one another by prefabrication before insertion into the bending actuator. The anchor element preferably extends substantially transversely to the direction of action of the shape memory. In this way, a good anchor effect is possible. Transverse grid bars of a grid-shaped shape memory element can act as anchor elements. Current can flow through the anchor element, said current serving to heat the shape memory element.

Embodiments of the invention are described by way of example below with reference to the attached figures. In the figures:

FIG. 1: shows a schematic plan view of a bending actuator with a shape memory element,

FIG. 2 shows a schematic view of an undeformed bending actuator with an enlarged detail of an intermediate layer between a base layer and a shape memory element,

FIG. 3 shows a schematic view of a deformed bending actuator,

FIG. 4a shows a schematic cross section through a bending actuator without an intermediate layer for comparison of the invention with the prior art, and

FIG. 4b shows a schematic cross section through a bending actuator according to the invention with an intermediate layer.

FIG. 1 schematically shows a plan view of a bending actuator 1. The bending actuator 1 comprises a base layer 2, to which an intermediate layer 6 is applied. The elasticity modulus of the intermediate layer 6 is lower than the elasticity modulus of the base layer 2. A shape memory element 3 is applied to the intermediate layer 6, said element comprising wires 3a and 3b made from shape memory alloy as well as an anchor wire 4. The anchor wire 4 is embedded in a plastics material (not shown), as a result of which it is connected positively and materially to the base layer 2. The intermediate layer 6 can be omitted at the location at which the plastics material for embedding the anchor wire 4 is situated. Furthermore, the bending actuator 1 comprises two connection wires 5a and 5b. The connection wires 5a and 5b are preferably arranged at least approximately transversely to the direction of action of the shape memory and, in this way, likewise act as anchor wires. They can be embedded in the same way as conventional anchor wires. Via the connection wires, as illustrated by arrows, an electric current can be introduced into and drawn from the bending actuator 1. A connection wire 5a, 5b preferably extends beyond the boundaries of the base layer, allowing good contact to be made therewith. The electric current flows from connection wire 5a to one or more of the wires 3a made from shape memory alloy, of which there are three in this illustrative embodiment. Via the anchor wire 4, the electric current flows to one or more further wires 3b made from shape memory alloy, of which there are likewise three in this illustrative embodiment. These three wires 3b are connected to connection wire 5b. Small arrows are used to illustrate the current flow through the shape memory element, which causes the shape memory element to heat up. This brings about a contraction of wires 3a and 3b, which, in turn, causes bending of the bending actuator out of the plane of FIG. 1 toward the observer.

FIG. 2 illustrates the construction of the bending actuator 1 by means of a schematic side view, which additionally comprises an enlarged detail of the bending actuator 1. The intermediate layer 6, which is illustrated on a greatly enlarged scale, is applied in contact with the schematically illustrated base layer 2. The intermediate layer 6 is illustrated by means of a multiplicity of small bearing symbols, which are intended to illustrate that the intermediate layer 6 creates a spacing between the base layer 2 and the shape memory element 3. At the same time, forces can be transmitted from the shape memory element 3 into the base layer 2 via the intermediate layer 6. In particular, the fastening locations of the shape memory element 3 move toward one another at the virtual bearing points of the intermediate layer 6 when the contraction of the shape memory element 3 occurs.

As illustrated schematically in FIG. 3, the contractions K, indicated by arrows, between the fastening points of the shape memory element 3 at the virtual bearing points of the intermediate layer 6 lead to bending of the base layer, including the intermediate layer and the shape memory element 3. There is a considerable deflection in comparison with an undeformed initial position A.

FIG. 4a schematically shows a cross section through a bending actuator 1 without an intermediate layer and thus shows the prior art. The bending actuator 1 has a neutral axis 7, which does not undergo any change in length during bending of the bending actuator in a direction of action of the shape memory. A prerequisite for successful bending is that the shape memory element 3 is arranged at a distance from the neutral axis 7. Shortening of the shape memory element 3 thus brings about bending of the bending actuator 1. By virtue of the relatively small distance between the shape memory element 3 and the neutral axis 7, extreme bending of the bending actuator 1 takes place. The contact surface 37 between the base layer and the shape memory element 3 is subjected to severe shear stress because of the extreme strain of the shape memory element 3, which can amount to 5%, for example. This is highly detrimental to the life of the bending actuator 1.

FIG. 4b schematically shows a cross section through a bending actuator 1 with an intermediate layer 6 and thus shows the invention. By virtue of the intermediate layer 6 inserted between the shape memory element 3 and the base layer 2, the neutral axis 7 is displaced in a direction of the shape memory element 3. The intermediate layer 6 brings about this displacement by virtue of its cross section in conjunction with its elasticity modulus. The intermediate layer 6 has a lower elasticity modulus than the base layer 2, and therefore the displacement of the neutral axis 7 is preferably slight. However, despite the displacement of the neutral axis 7, the spacing which the intermediate layer 6 creates between the shape memory element 3 and the base layer 2 means that the shape memory element 3 is considerably further away from the neutral axis 7 than in the prior art shown in FIG. 4a. This results in significantly reduced bending of the bending actuator 1 for the same contraction of the shape memory element 3. Moreover, the extreme strain of the shape memory element 3 is transmitted by the soft intermediate layer 6 to the base layer 2, wherein the large difference in strain can be compensated. Owing to its flexibility, the intermediate layer 6 results in a significantly extended life of the bending actuator 1, this also including, in particular, the connecting surfaces 62, 63 between the intermediate layer 6 and the base layer 2 and the shape memory element 3, respectively.

1. A bending actuator, which
comprises a plastic base layer and a shape memory element made from shape memory material, which can be actively shortened in a direction of action of the shape memory, wherein the shape memory element is arranged outside the base layer and is mechanically connected to the base layer, such that the bending actuator is designed for bending to occur in the bending actuator because of tension due to contraction of the shape memory element in a direction of action of the shape memory,
wherein an intermediate layer, the elasticity modulus of which is less than the elasticity modulus of the base layer, is arranged between the shape memory element and the base layer,
characterized in that the base layer is produced from a plastic reinforced with long fibers, a plastic reinforced with short fibers or a plastic which is not reinforced with fibers, and the intermediate layer is made of an elastomer.

2. The bending actuator as claimed in claim 1, characterized in that the elasticity modulus of the intermediate layer is one tenth or less of the elasticity modulus of the base layer.

3. The bending actuator as claimed in claim 1, characterized in that the intermediate layer between the base layer and the shape memory element has the effect that the neutral axis is displaced by at most 10% of the thickness of the intermediate layer in comparison with a bending actuator without the intermediate layer.

4. The bending actuator as claimed in claim 1, characterized in that the thickness of the intermediate layer is at least 50% of the thickness of the base layer.

5. The bending actuator as claimed in claim 1, characterized in that the base layer is formed as an elongate strip.

6. The bending actuator as claimed in claim 1, characterized in that the shape memory element has substantially the shape of one or more.

7. The bending actuator as claimed in claim 1, characterized in that the shape memory element is anchored against displacement in a direction of action of the shape memory at at least one end of the base layer, in particular by at least one anchor wire, which is connected to the shape memory element.

8. The bending actuator as claimed in claim 1, characterized in that the elasticity modulus of the intermediate layer is one hundredth or less of the elasticity modulus of the base layer.

9. The bending actuator as claimed in claim 1, characterized in that the base layer is formed as an elongate strip, wherein the shape memory element extends at least approximately from one end of the base layer in the longitudinal direction to the other end of the base layer in longitudinal direction.

10. The bending actuator as claimed in claim 1, characterized in that the shape memory element has substantially the shape of one or more wires, which are arranged parallel to one another and in one plane.

11. The bending actuator as claimed in claim 1, characterized in that the shape memory element is anchored against displacement in a direction of action of the shape memory at at least one end of the base layer, in particular by at least one anchor wire, which is connected to the shape memory element and is embedded in plastic, which is mechanically connected to the base layer.
